(19) United States
(12) Patent Application Publication
(10) Pub. No.: US 2010/0031372 A1
(43) Pub. Date: Feb. 4, 2010

(54) METHOD AND SYSTEM FOR SECURE FLEXIBLE SOFTWARE LICENSING

(75) Inventor: Laurence HAMID, Ottawa (CA)

Correspondence Address: FREEDMAN & ASSOCIATES, 117 CENTREPOINTE DRIVE, SUITE 350, NEPEAN, ONTARIO, K2G 5X3, CA

(73) Assignee: MEMORY EXPERTS INTERNATIONAL INC., Montreal (CA)

(21) Appl. No.: 12/511,131

(22) Filed: Jul. 29, 2009

Related U.S. Application Data
(60) Provisional application No. 61/084,354, filed on Jul. 29, 2008.

(51) Int. Cl. G06F 21/00

(52) U.S. Cl. 726/28

(57) ABSTRACT

When executing a licensing management application, data indicative of licensing privileges of a software application for simultaneous execution on a subset of a plurality of computers are received from a licensor of the software application. The data indicative of licensing privileges comprise data indicative of a licensing key. For each of a plurality of users a peripheral licensing device is provided and the data indicative of a licensing key are then stored in memory thereof. Data indicative of a total number of users—equal to a number of the subset—are determined and provided to the licensor, or storage of the licensing key is prevented, when the total number is greater than a predetermined number of the subset. After execution of the licensing management application and provision of each of the users with a respective peripheral licensing device, each of the users is enabled to execute the software application by interfacing the peripheral licensing device with one of the computers, after which the data indicative of a licensing key are retrieved and the software application is executed.

### FIELD OF THE INVENTION

The instant invention relates generally to software licensing, and more particularly to a method and system for secure flexible software licensing in multiple license applications.

### BACKGROUND OF THE INVENTION

Using present day technologies, software is, unlike manufactured goods, easily copied and distributed. Hence, software providers have to develop effective mechanisms for preventing unlawful copying and proliferation of proprietary software. Software is not purchased, but only licensed for use. Unfortunately, a software license is merely a legal mechanism and does not prevent unlawful copying and proliferation of proprietary software. A significant amount of software piracy occurs in commercial and institutional settings. In general, commercial and institutional licensees are vigilant about license compliance. However, even the most attentive system administrator is not able to prevent dishonest employees from copying software from a company computer for their personal benefit.

At present, software providers face the dilemma of effectively preventing unlawful copying and proliferation of their proprietary software whilst allowing flexible use of their proprietary software for their legitimate customers.

State of the art techniques for preventing unlawful copying comprise use of a digital license key that enables use of the software under predetermined conditions on a specific computer. In order to add more flexibility, some software providers provide the digital license key stored in a dongle enabling a user to use the software on one of a plurality of devices by connecting the dongle to the respective device.

Particularly difficult is the prevention of unlawful copying in commercial and institutional settings. State of the art commercial and institutional software licenses for use on a plurality of devices are of two types: “fixed” and “floating”.

A fixed license permits a software application to be used on designated devices only, for example, on 10 designated computers out of 30 computers in an office. As is evident, this type of software licensing is highly inflexible and cumbersome. For example, an employee using a specific software application has to track down a computer with the specific software application installed when working at a different location within a corporation, resulting in a tedious and time wasting process of trial and error. Managing fixed licenses requires a high degree of manual effort which escalates with the number of computers and licenses.

A floating license permits simultaneous use of a software application on a predetermined number of computers of a plurality of computers. For example, a floating license allows simultaneous use of a software application on any 100 computers of 1000 computers in a corporate network. A licensing server of the corporate network monitors the number of floating licenses used. Unfortunately, while providing more flexibility, this type of software licensing has also its major disadvantages. When starting a software application on a computer of the corporate network, a request for a license key is sent to the licensing server which then checks the availability of a license key and—if available—sends a license key to the computer. As is evident, such a process does not only result in a considerable delay in opening the software application but also puts a considerable strain on the corporate network due to increased traffic for the licensing process. Furthermore, when the license server is down or when there is an interruption in the corporate network, it is impossible to open a licensed software application. Another disadvantage of the floating licensing approach is the possibility that a user wants to open a software application and all licenses are used, i.e. the user is prevented from opening the software application. This scenario is even possible when the number of licenses is equal to the number of all employees authorized to use a specific software application when, for example, an unauthorized employee has opened the software application or when an authorized employee has opened the software application on two computers.

It would be advantageous to provide a system and method that overcomes at least some of the drawbacks of the present technology in multiple license applications.

### SUMMARY OF THE INVENTION

It is, therefore, an object of aspects of the invention to provide a method and system for secure flexible software licensing in multiple license applications.

In accordance with an aspect of the present invention there is provided a method comprising:
providing a licensing management application;

receiving data indicative of licensing privileges of a software application for simultaneous execution on a subset of a plurality of computers having the software application installed thereon, the data indicative of licensing privileges comprising data indicative of a licensing key, the data indicative of licensing privileges being received by the licensing management application;

providing for each of a plurality of users a peripheral licensing device, the peripheral licensing device for being interfaced with one of the computers prior to execution of the software application;

storing the data indicative of a licensing key in memory of each of the peripheral licensing devices, the data indicative of a licensing key for being provided prior execution of the software application;

determining data indicative of a total number of users; and,

performing one of providing the data indicative of the total number to a licensor of the software application and preventing storage of the licensing key when the total number is greater than a predetermined number of the subset.

In accordance with an aspect of the present invention there is provided a method comprising:
providing a licensing management application;

receiving data indicative of licensing privileges of a software application for simultaneous execution on a subset of a plurality A of computers having the software application installed thereon, the data indicative of licensing privileges comprising respective licensing device identification data of each of a plurality B of peripheral licensing devices, the data indicative of licensing privileges being received by the licensing management application;

storing the respective licensing device identification data of each of the plurality B of peripheral licensing devices in memory accessible to the licensing management application;

receiving the plurality B of peripheral licensing devices from a licensor of the software application, each peripheral licensing device having stored thereon data indicative of a licensing key and the respective licensing device identification data, the data indicative of a licensing key for being provided prior execution of the software application;

providing each of a plurality C of users with one of the plurality B of peripheral licensing devices, the peripheral licensing device for being interfaced with one of the computers prior to execution of the software application;

generating a list of respective licensing device identification data of peripheral licensing devices provided to the users and storing the same in the memory accessible to the licensing management application;

determining data indicative of a total number of users; and,

performing at least one of providing the data indicative of the total number to a licensor of the software application and providing the list of respective licensing device identification data of peripheral licensing devices provided to the users to the licensor of the software application.

In accordance with an aspect of the present invention there is provided a method comprising:
providing a licensing management application;
executing the licensing management application performing:
   determining data indicative of a plurality A of peripheral licensing devices, each of the peripheral licensing devices for being interfaced with one of a plurality B of computers having a software application installed thereon to enable simultaneous execution of the software application on a subset C of the plurality B of computers by providing a licensing key, the plurality A being greater than the subset C;
   determining data indicative of user privileges associated with each of the plurality A of peripheral licensing devices;
   determining the subset C in dependence upon the data indicative of user privileges associated with each of the plurality A of peripheral licensing devices; and,
   providing the data indicative of the plurality A, the data indicative of user privileges associated with each of the plurality A of peripheral licensing devices and the data indicative of the subset C to a licensor of the software application;
receiving the plurality A of peripheral licensing devices from the licensor of the software application, each peripheral licensing device having stored thereon data indicative of a licensing key and the data indicative of user privileges associated therewith, the data indicative of a licensing key and the data indicative of user privileges for being provided prior execution of the software application; and,
providing each of the plurality A of peripheral licensing devices to a respective user, the peripheral licensing device for being interfaced with one of the plurality B of computers prior to execution of the software application.

In accordance with an aspect of the present invention there is provided a storage medium having stored thereon executable commands for execution on a processor of a host computer, the processor when executing the commands performing:

receiving data indicative of licensing privileges of a software application for simultaneous execution on a subset of a plurality of computers having the software application installed thereon, the data indicative of licensing privileges comprising data indicative of a licensing key;

determining data indicative of a total number of users;

storing the data indicative of a licensing key in memory of each of the peripheral licensing devices, the data indicative of a licensing key for being provided prior execution of the software application; and,

performing one of providing the data indicative of the total number to a licensor of the software application and preventing storage of the licensing key when the total number is greater than a predetermined number of the subset.

In accordance with an aspect of the present invention there is provided a system comprising:
a plurality A of peripheral licensing devices, each of the peripheral licensing devices for being interfaced with one of a plurality B of computers having a software application installed thereon, each of the plurality A of peripheral licensing devices comprising:
   a port for communicating with a host computer; and,
   memory connected to the port, the memory having stored thereon data indicative of a licensing key of the software application and respective licensing device identification data;
and,
a storage medium having stored thereon executable commands for execution on a processor, the processor when executing the commands executing a licensing management application and performing:
   receiving data indicative of licensing privileges of a software application for simultaneous execution on a subset of the plurality B of computers having the software application installed thereon, the data indicative of licensing privileges comprising respective licensing device identification data of each of the plurality A of peripheral licensing devices;
   storing the respective licensing device identification data of each of the plurality A of peripheral licensing devices in memory accessible to the licensing management application;
   generating a list of respective licensing device identification data of peripheral licensing devices provided to the users and storing the same in the memory accessible to the licensing management application;
   determining data indicative of a total number of users; and,
performing at least one of providing the data indicative of the total number to a licensor of the software application and providing the list of respective licensing device identification data of peripheral licensing devices provided to the users to the licensor of the software application.

In accordance with an aspect of the present invention there is provided a system comprising:
a storage medium having stored thereon executable commands for execution on a processor, the processor when executing the commands executing a licensing management application and performing:
   determining data indicative of a plurality A of peripheral licensing devices, each of the peripheral licensing devices for being interfaced with one of a plurality B of computers having a software application installed thereon to enable simultaneous execution of the software application on a subset C of the plurality B of computers by providing a licensing key, the plurality A being greater than the subset C;
   determining data indicative of user privileges associated with each of the plurality A of peripheral licensing devices;
   determining the subset C in dependence upon the data indicative of user privileges associated with each of the plurality A of peripheral licensing devices; and,
   providing the data indicative of the plurality A, the data indicative of user privileges associated with each of the plurality A of peripheral licensing devices and the data indicative of the subset C to a licensor of the software application;
and,

a plurality A of peripheral licensing devices, each of the peripheral licensing devices for being interfaced with one of a plurality B of computers having a software application installed thereon to enable simultaneous execution of the software application on a subset C of the plurality B of computers by providing a licensing key, the plurality A being greater than the subset C, each of the peripheral licensing devices comprising:

a port for communicating with a host computer; and,
memory connected to the port, the memory having stored thereon data indicative of a licensing key of the software application and data indicative of user privileges associated with the peripheral licensing device.

### BRIEF DESCRIPTION OF THE FIGURES

Exemplary embodiments of the invention will now be described in conjunction with the following drawings, in which:

FIG. 1 is simplified block diagram illustrating a computer system for implementing the various embodiments of a method for secure flexible software licensing, according to an embodiment of the invention;

FIGS. 2a to 2e are simplified flow diagrams of a first embodiment of a method for secure flexible software licensing according to the invention;

FIGS. 3a and 3b are simplified flow diagrams of a second embodiment of a method for secure flexible software licensing according to the invention;

FIG. 4 is simplified flow diagram of a third embodiment of a method for secure flexible software licensing according to the invention; and,

FIG. 5 is a simplified block diagram of a peripheral licensing device of a system for secure flexible software licensing according to the invention.

### DETAILED DESCRIPTION OF THE INVENTION

The following description is presented to enable a person skilled in the art to make and use the invention, and is provided in the context of a particular application and its requirements. Various modifications to the disclosed embodiments will be readily apparent to those skilled in the art, and the general principles defined herein may be applied to other embodiments and applications without departing from the scope of the invention. Thus, the present invention is not intended to be limited to the embodiments disclosed, but is to be accorded the widest scope consistent with the principles and features disclosed herein.

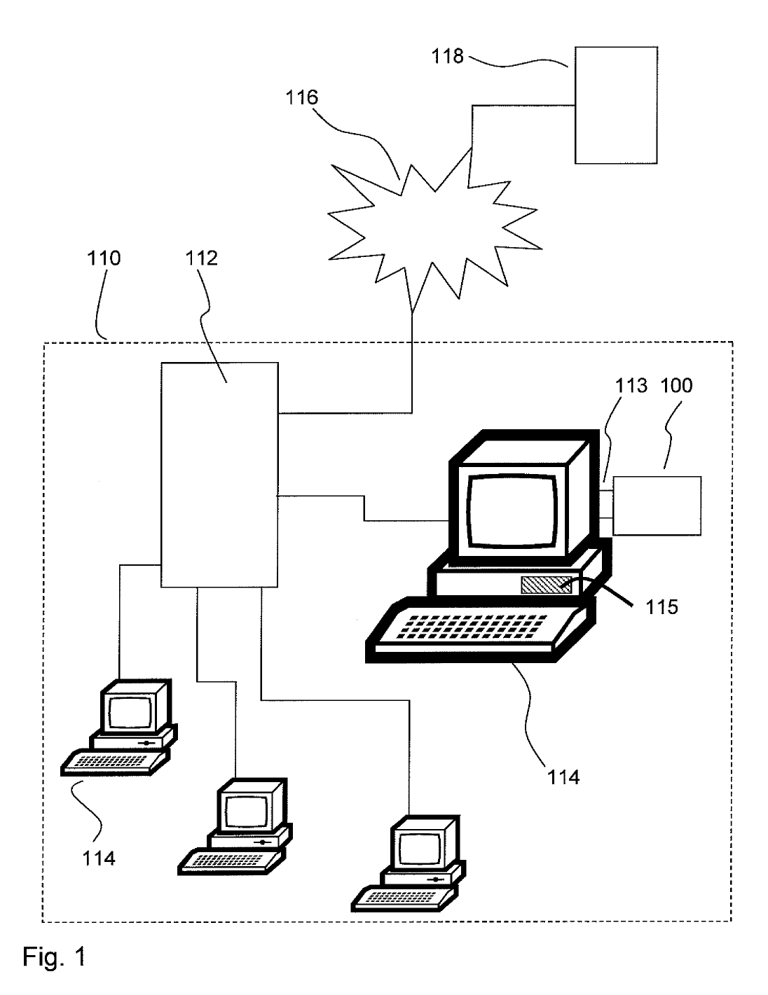

For the sake of clarity, the various embodiments of a method for secure flexible software licensing according to the invention will be described in an implementation on a computer system shown in FIG. 1, but as will become evident is not limited thereto. For example, a corporate network 110 such as a Local Area Network (LAN) comprises a plurality of computers or workstations 114 having a software application installed thereon. The plurality of computers 114 are connected to a server 112. The corporate network 110 is connected to a computer network 116, for example, the Internet, via the server 112, to which a server 118 of a licensor of the software application is connected. It will become evident to those skilled in the art that the embodiments of the invention described hereinbelow are not limited thereto, but are also implementable on various other computer systems, for example, computer networks absent a connection between the server 112 and 118, or the software application being provided via a peripheral device connected to the workstation 114.

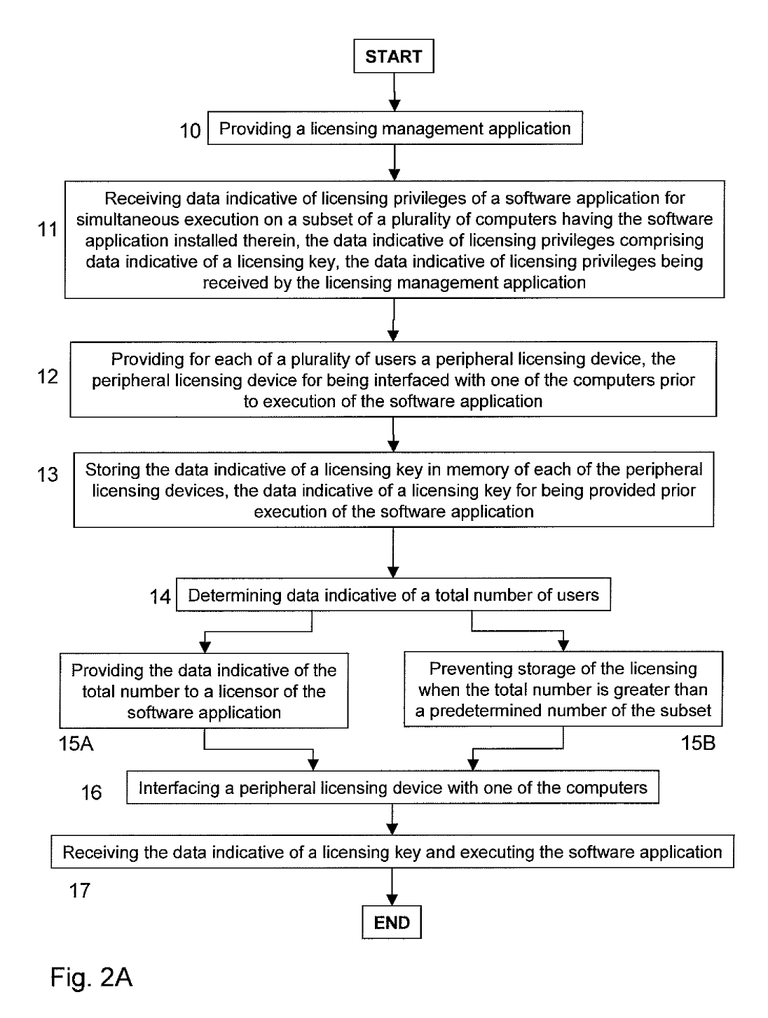

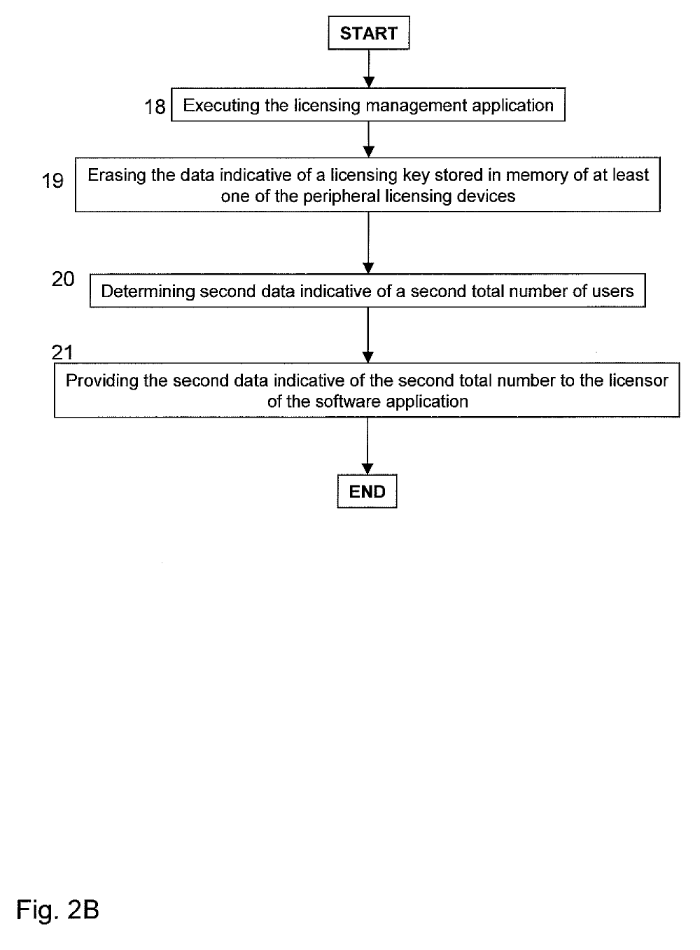

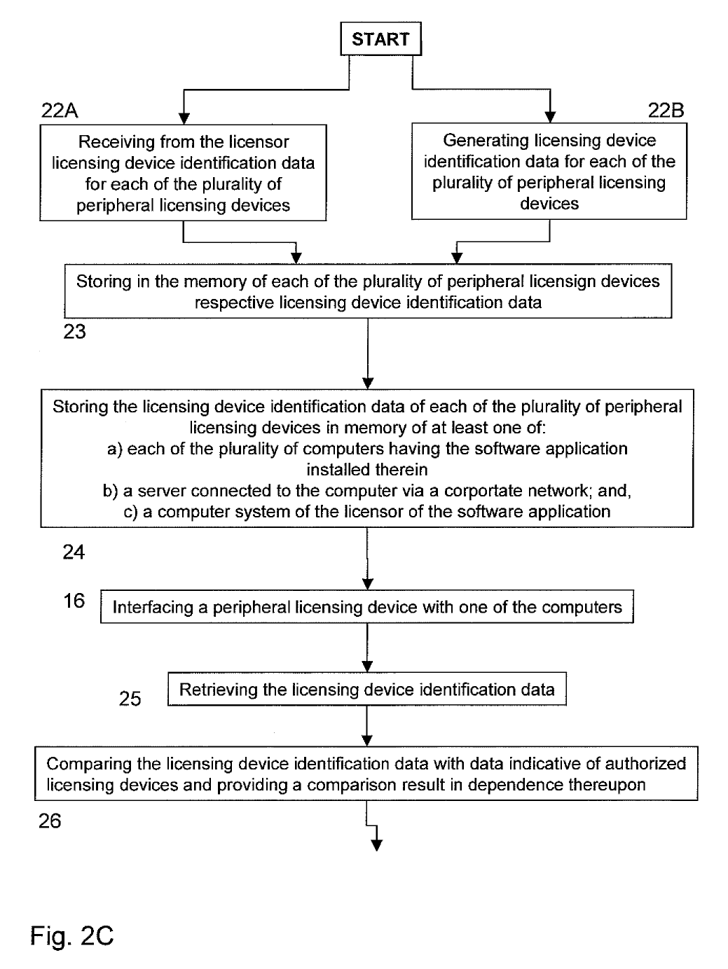

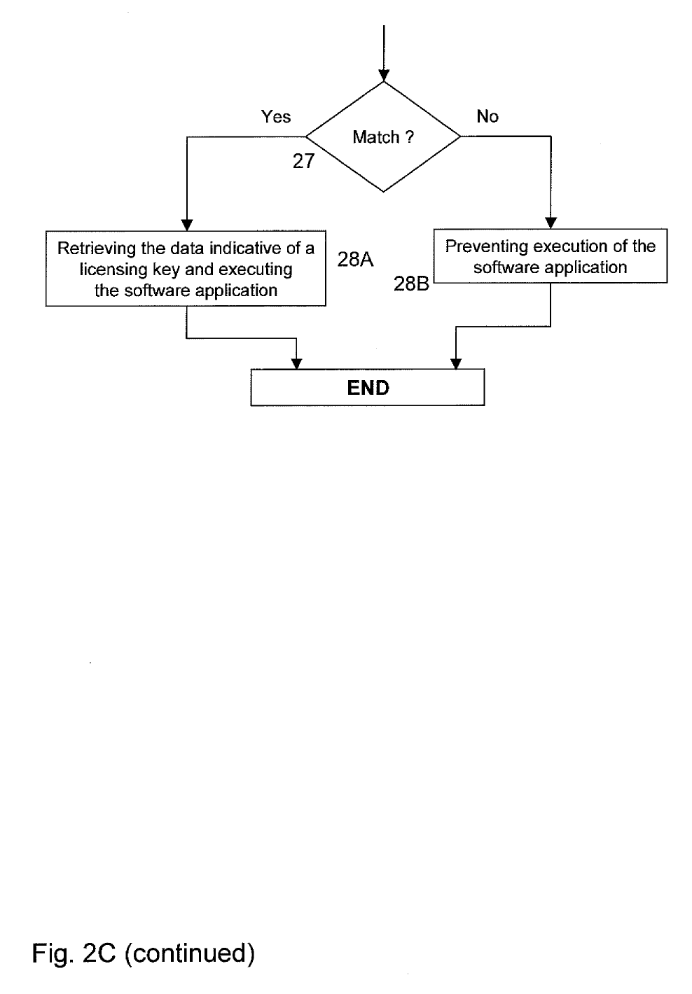

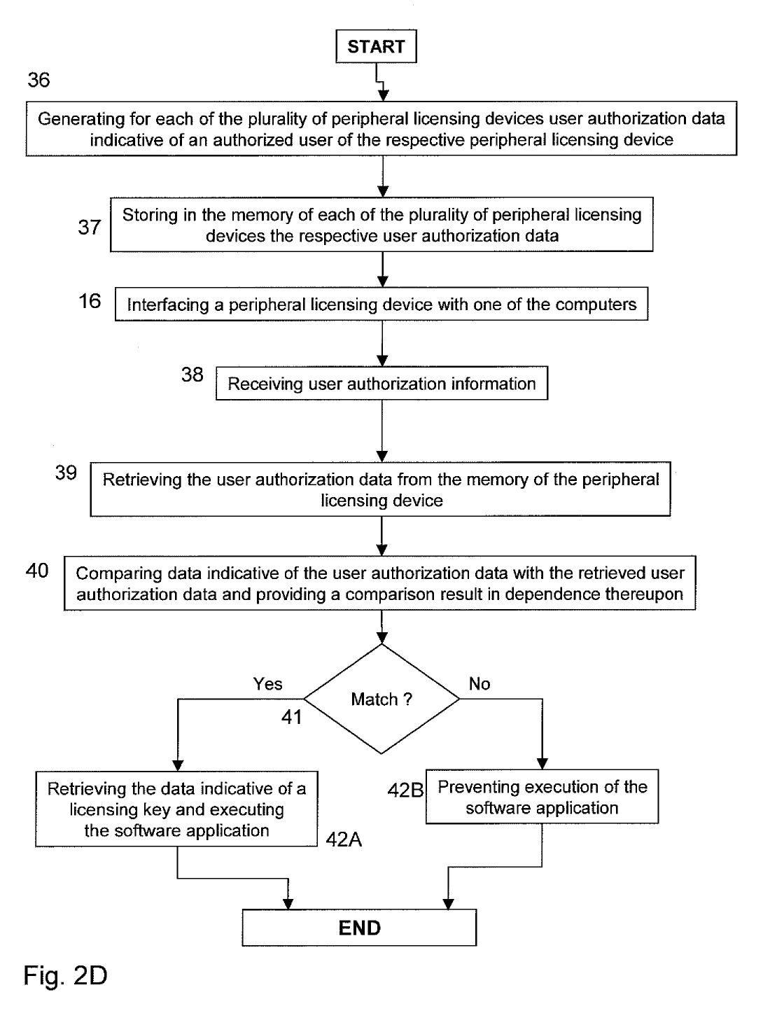

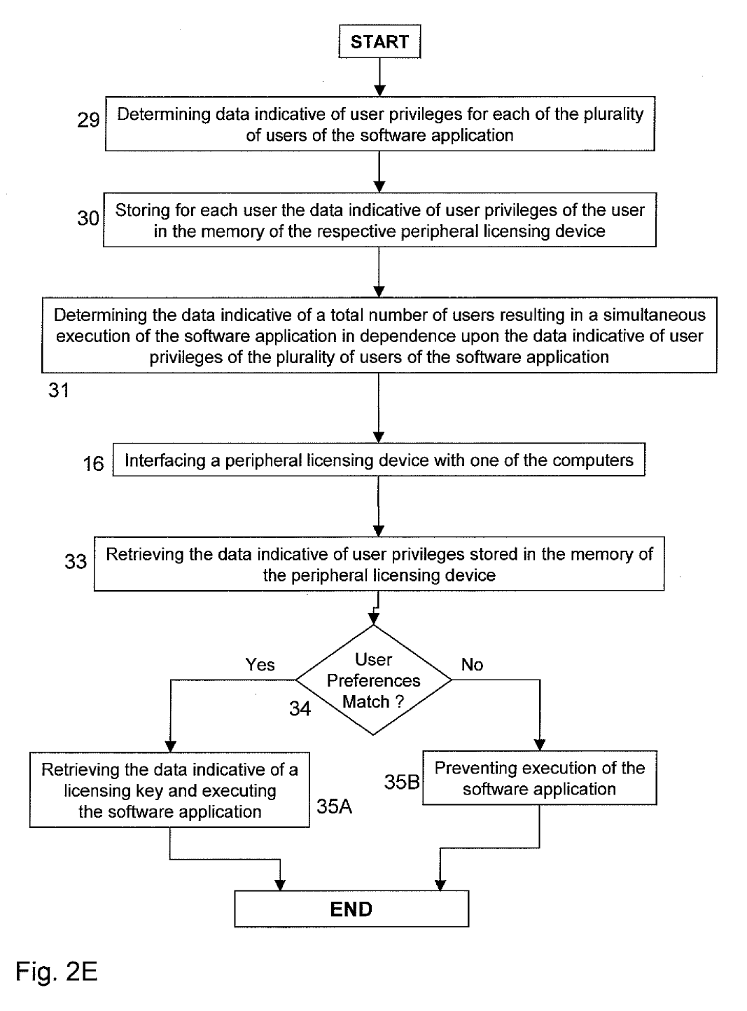

Referring to FIGS. 2a to 2e, simplified flow diagrams of a first embodiment of the method for secure flexible software licensing according to the invention are shown. At 10, shown in FIG. 2a, a licensing management application is provided, for example, as a download from the licensor's server 118 via the computer network 116 or stored as executable commands on a storage medium such as, for example, a CD or DVD. The licensing management application is then installed and executed by a system administrator, for example, on the server 112. When executing the licensing management application, data indicative of licensing privileges of the software application for simultaneous execution on a subset of the plurality of computers 114 are received from the licensor of the software application—11. The data indicative of licensing privileges comprise data indicative of a licensing key and, optionally, data indicative of a predetermined number of the subset. The data are, for example, provided in an obfuscated fashion as encoded data to increase security. Encoding of data using, for example, one of numerous available encryption techniques is well known in the art. Alternatively, the data are digitally signed to avoid tampering and/or forgery. At 12, for each of a plurality of users a peripheral licensing device 100 is provided. The peripheral licensing device 100 is a portable device such as, for example, a Universal Serial Bus (USB) memory storage key for being interfaced with a USB port 113 of one of the computers 114 prior to execution of the software application. Alternatively, the peripheral licensing device 100 is a flash memory card for being interfaced with a smart card reader 115 connected to one of the computers 114. For example, off-the-shelf USB memory storage keys or flash memory cards are used as peripheral licensing devices 100. The data indicative of a licensing key—received from the licensor at 11—are then stored in memory of each of the peripheral licensing devices 100—at 13. The data indicative of a licensing key are for being provided prior to execution of the software application. The data are, for example, stored in an obfuscated fashion, for example, as encoded data, to increase security. At 14, data indicative of a total number of users—equal to a number of the subset—is determined. It is possible to perform this step before, after, or during the storage of the licensing key at 13 In order to ensure compliance with a licensing agreement with the licensor of the software application, the licensing management application performs one of providing the data indicative of the total number to the licensor of the software application—at 15A, for example, for billing purposes; and preventing storage of the licensing key when the total number is greater than the predetermined number of the subset—at 15B. Providing the data indicative of the total number to the licensor—15A—allows implementation of a more flexible licensing agreement than the more static solution of preventing storage of the licensing key—15B, as will be described in more detail hereinbelow.

After execution of the licensing management application and provision of each of the users with a respective peripheral licensing device 100, each of the users is enabled to execute the software application by interfacing the peripheral licensing device 100 with one of the computers 114—at 16—after which the data indicative of a licensing key are retrieved and the software application is executed—at 17. Of course, when the data indicative of a licensing key are stored in an obfuscated fashion a step of decoding of the data is executed after their retrieval, which is performed using, for example, a processor of the computer 114.

As is evident, the method for secure flexible software licensing according to the above-described embodiment of the instant invention overcomes at least some of the drawbacks of the state of the art “fixed” as well as “floating” types of licenses. Firstly, it provides the advantage of the “floating” type of software license by enabling simultaneous use of a software application on, for example, any 100 computers of 1000 computers in a corporate network having the software application installed thereon. Secondly, it overcomes the drawbacks of the state of the art “floating” type license by obviating the need of communication between a licensing server and the computers in order to control compliance with the licensing agreement and to provide the licensing key to the computer prior to each execution of the software application. Furthermore, it avoids the situation in which a user is prevented from executing the software application because all licenses are used. The method for secure flexible software licensing according to the invention is also advantageous for the software licensor by providing a simple control mechanism for controlling compliance with a licensing agreement through communication with the licensing management application.

Referring to FIG. 2b, an additional feature increasing flexibility is provided. Here, the licensing management application is executed—18—to erase the data indicative of a licensing key stored in memory of at least one of the peripheral licensing devices—at 19, for example, by enabling communication between the licensing management application and the memory of the at least one peripheral licensing devices 100 for the licensing management application to securely erase the data indicative of a licensing key using, for example, a predetermined method of overwriting the data having a predetermined level of security. At 20, second data indicative of a second total number of users are determined and then provided to the licensor of the software application.

This feature provides benefits for the licensee as well as for the licensor. It enables the licensee to easily reduce the number of licenses for simultaneous executions of the software application in situations such as, for example, when downsizing the number of users or when there is a seasonal variation of the number of users. For example, provision of the second total number allows adjustment of the billing according to the reduced number of users. The benefit for the licensor is that there is no need for canceling an existing and providing a new licensing agreement to allow for fluctuations of the number of users.

Of course, it is also possible to increase the number of users by storing the data indicative of a licensing key in at least one additional peripheral storage device 100, determining third data indicative of a third total number of users and then providing it to the licensor of the software application.

Referring to FIG. 2c, a simplified flow diagram of another additional feature of the method for secure flexible software licensing according to the above-described embodiment of the invention is shown. Here, security is increased by allocating respective licensing device identification data to each of the plurality of peripheral licensing devices. When executing the licensing management application, the licensing device identification data for each of the plurality of peripheral licensing devices 100 are received from the licensor—at 22A. Alternatively, the licensing device identification data for each of the plurality of peripheral licensing devices 100 are generated—22B—using, for example, a processor of the server 112. For example, the licensing device identification data are generated according to predetermined instructions provided by the licensor. The respective licensing device identification data are then stored in the memory of each of the plurality of the peripheral licensing devices 100—at 23. Additionally, the licensing identification data of each of the plurality of peripheral licensing devices 100 are provided to and stored—at 24—in at least one of: each of the computers 114; the server 112, and the server 118. The licensing identification data are, for example, stored in an obfuscated fashion, for example, as encoded data, to increase security. Alternatively, the data are digitally signed to avoid tampering and/or forgery.

After interfacing a peripheral licensing device 100 with one of the computers 114—at 16—the licensing device identification data are retrieved—at 25—and compared—at 26 with data of authorized peripheral licensing devices, i.e. the data stored in step 24, to provide a comparison result in dependence thereupon—27. If the comparison result is indicative of a match, the data indicative of a licensing key are retrieved and the software application is executed—28A. If the comparison result is indicative of other than a match, execution of the software application is prevented—28B. For example, in step 24 the licensing identification data of each of the plurality of peripheral licensing devices 100 are stored in each of the computers 114 and the comparison process is performed using a processor of the computer 114. Alternatively, the comparison process is performed using the server 112, or the server 118, however, at the cost of additional communication traffic in the corporate network 110 and dependence upon the network communication and the operation of the server 112 or the servers 112 and 118, respectively. Of course, when the licensing identification data are stored in an obfuscated fashion a step of decoding of the data is executed after their retrieval, which is performed using, for example, the processor of the computer 114.

Here, security is increased by enabling retrieval of the data indicative of a licensing key only after successful identification of the peripheral licensing device as an authorized device and/or a user of the same being identified as an authorized user. User authentication might also be used to release the licensing key). Furthermore, this feature allows a further increase of security by erasing the licensing device identification data of a peripheral licensing device from the data stored in step 24, for example, when the peripheral licensing device is malfunctioning, lost, or stolen.

Optionally, data relating the licensing device identification data to a respective user are generated and stored, for example, in the server 112, thus simplifying tracking of the peripheral licensing devices 100. For example, when an employee has left the corporation but kept the peripheral licensing device 100, a system administrator is able to easily determine the respective licensing device identification data and to erase the same from the data stored in step 24.

Further optionally, the peripheral licensing devices 100 are provided by the licensor of the software application with each peripheral licensing device having the respective licensing device identification data stored in memory thereof, for example, in a tamper resistant fashion.

Referring to FIG. 2d, a simplified flow diagram of yet another additional feature of the method for secure flexible software licensing according to the above-described embodiment of the invention is shown. Here, the level of security is increased by generating and storing user authorization data of an authorized user, allocated to the respective peripheral licensing device 100. When executing the licensing management application, the user authorization data indicative of an authorized user of the respective peripheral licensing device 100 is generated for each of the plurality of peripheral licensing devices 100—at 36. The user authorization data are, for example, indicative of an access code such as a password or biometric information such as fingerprint information of the respective authorized user. The respective user authorization data are then stored in the memory of each of the plurality of peripheral licensing devices 100—at 37. The user authorization data are, for example, stored in an obfuscated fashion, for example, as encoded data, to increase security.

After interfacing a peripheral licensing device 100 with one of the computers 114—at 16, the user is prompted to provide user authorization information, for example, to type in the password or to provide biometric information to a biometric input device, for example, a fingerprint scanner, connected to the computer 114 or disposed in the peripheral licensing device 100. After receipt of the user authorization information—at 38—the user authorization data are retrieved from the memory of the peripheral licensing device 100—at 39—and data indicative of the user authorization information are then compared with the retrieved user authorization data—at 40—and a comparison result in dependence thereupon is provided—at 41. If the comparison result is indicative of a match, the data indicative of a licensing key are retrieved and the software application is executed—42A. If the comparison result is indicative of other than a match, execution of the software application is prevented—42B. For example, the comparison—step 40—is performed using a processor of the computer 114 or, alternatively using a logic circuit disposed in the peripheral licensing device 100. Of course, when the user authorization data are stored in an obfuscated fashion a step of decoding of the data is executed after their retrieval, which is performed using, for example, the processor of the computer 114 or, alternatively, the logic circuit disposed in the peripheral licensing device 100.

Here, the level of security is increased by enabling retrieval of the data indicative of a licensing key only after successful identification of the user of the peripheral licensing device 100 as an authorized user, i.e. when the peripheral licensing device 100 is lost or stolen an unauthorized user is prevented from executing the software application.

Referring to FIG. 2e, a simplified flow diagram of yet another additional feature of the method for secure flexible software licensing according to the invention is shown. Here, flexibility is increased by determining user privileges of a user of a peripheral licensing device 100 and storing data indicative thereof in the memory of the respective peripheral licensing device 100. When executing the licensing management application, data indicative of user privileges for each of the plurality of users of the software application are determined—at 29. The respective data indicative of user privileges are then stored in the memory of each of the plurality of peripheral licensing devices 100—at 30. The data indicative of user privileges are, for example, stored in an obfuscated fashion, for example, as encoded data, to increase security. At 31, data indicative of a total number of users—equal to a number of the subset—are determined. Here, the total number of users is determined in dependence upon the data indicative of user privileges of each of the plurality of users of the software application.

After interfacing a peripheral licensing device 100 with one of the computers 114—at 16—the data indicative of user privileges stored in the memory of the peripheral licensing device 100 are retrieved—at 33—and independence upon the retrieved data indicative of user privileges—at 34—the data indicative of a licensing key are retrieved and the software application is executed—35A—or execution of the software application is prevented—35B. Of course, when the licensing identification data are stored in an obfuscated fashion a step of decoding of the data is executed after their retrieval, which is performed using, for example, the processor of the computer 114 or, alternatively, a logic circuit disposed in the peripheral licensing device 100.

For example, the user privileges are determined based on time, enabling employees to execute the software application only during their regular working hours or, in another aspect enabling employees to execute the software application only on workdays but not on weekends and statutory holidays. After their retrieval, the data indicative of user privileges are compared with data indicative of at least one of time and date provided, for example, by a processor of the computer 114, using, for example, the processor of the computer 114, a logic circuit disposed in the peripheral licensing device, or a processor of the server 112. This feature supports variation of the total number of users—i.e. number of simultaneous executions of the software application. For example, a license agreement allows 1000 simultaneous executions of the software application on workdays but only 50 on weekends and statutory holidays, reflecting the different use on different days of the week. Optionally, the user privileges are determined based on enabled functions of the software application. For example, a majority of employees uses only functions of a basic version of a software application while the tasks of only a small number of employees require use of a professional version of the software application. Using user privileges allows installation of the professional version on all computers 114 and users are then enabled to execute the basic version or the professional version according to their respective user privileges. Therefore, this feature—using at least one of time based and function based user privileges—substantially increases flexibility for software licensing while compliance with a licensing agreement is ensured.

As is evident, while each of the additional features above has been described separately for clarity, it possible to integrate several of the additional features in various combinations in the method for secure flexible software licensing according to the above-described embodiment of the invention, in order to satisfy predetermined degrees of flexibility and security.

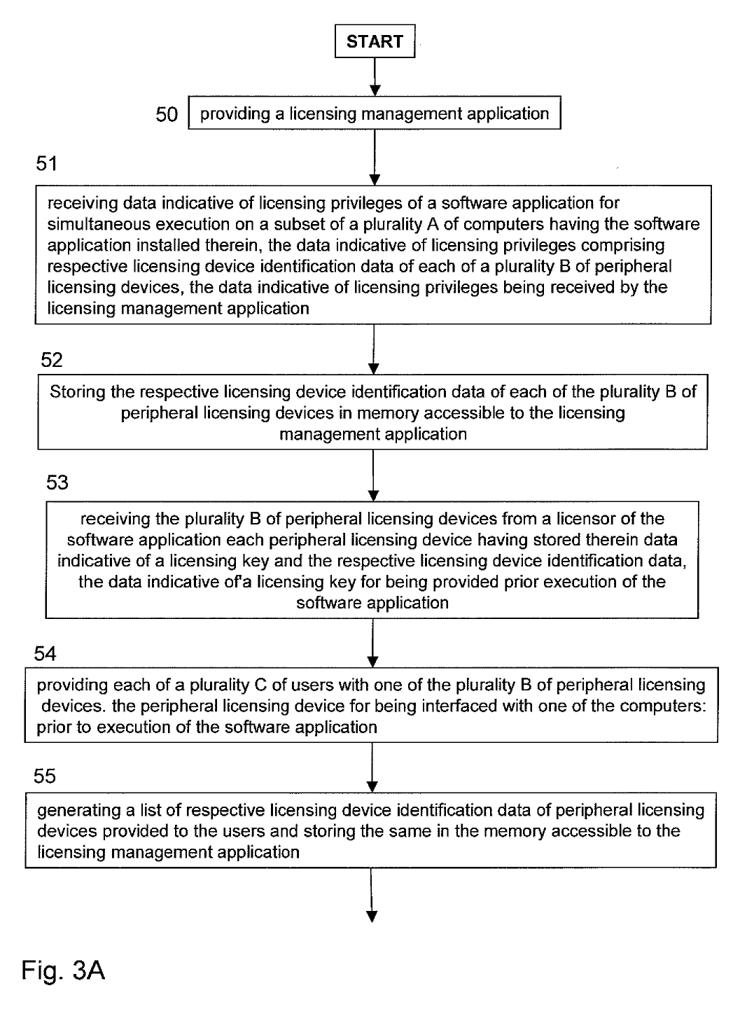

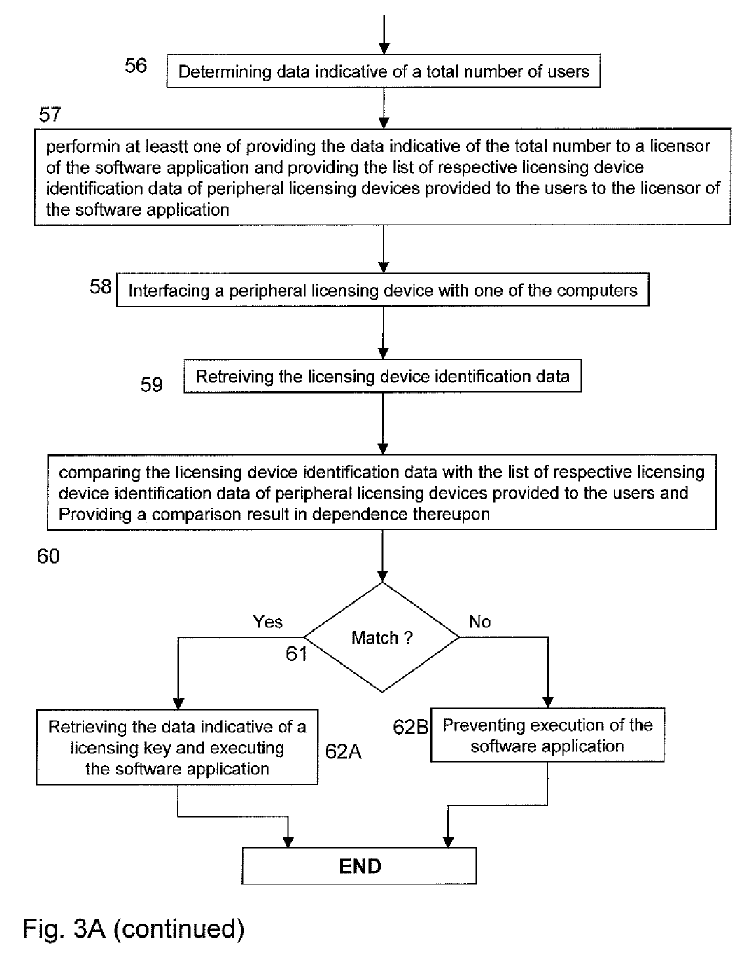

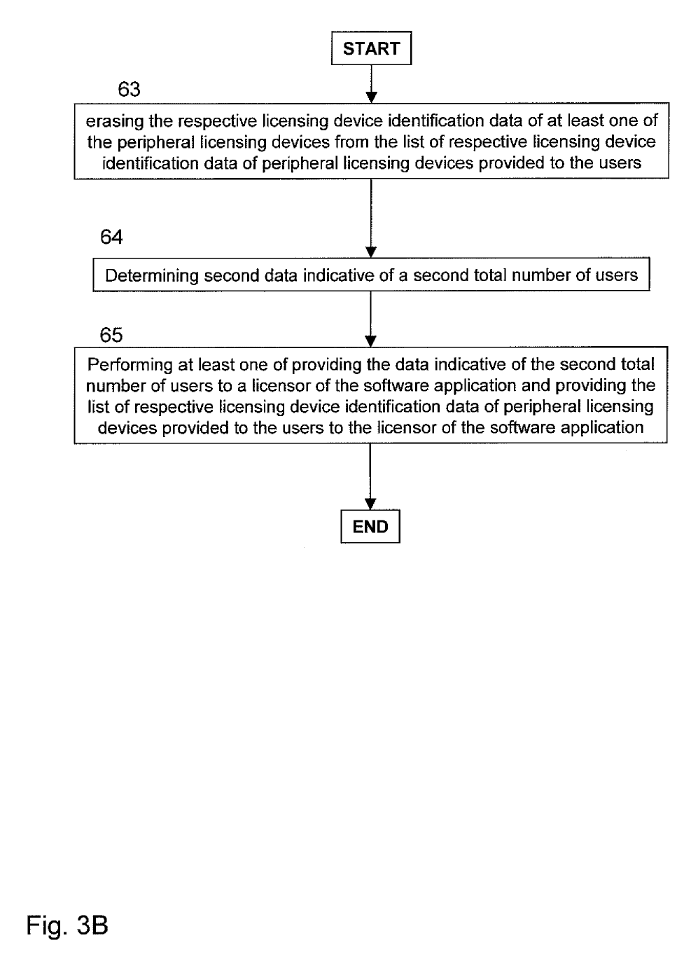

Referring to FIGS. 3a and 3b, simplified flow diagrams of a second embodiment of the method for secure flexible software licensing according to the invention are shown. At 50, shown in FIG. 3a, a licensing management application is provided, for example, as a download from the licensor's server 118 via the computer network 116 or stored as executable commands on a storage medium such as, for example, a CD or DVD. The licensing management application is then installed and executed by a system administrator, for example, on the server 112. When executing the licensing management application, data indicative of licensing privileges of the software application for simultaneous execution on a subset of the plurality A of computers 114 are received from the licensor of the software application—51. The data indicative of licensing privileges comprise respective licensing device identification data of each of a plurality B of peripheral licensing devices 100. The data are, for example, provided in an obfuscated fashion, for example, as encoded data, to increase security.

The respective licensing device identification data of each of the plurality B of peripheral licensing devices 100 are then stored in memory accessible to the licensing management application—at 52, for example, memory of the server 112. At 53, the plurality B of peripheral licensing devices is received from a licensor of the software application. Each peripheral licensing device has stored in memory data indicative of a licensing key and the respective licensing device identification data. The peripheral licensing device 100 is a portable device such as, for example, a Universal Serial Bus (USB) memory storage key for being interfaced with a USB port 113 of one of the computers 114 prior to execution of the software application. Alternatively, the peripheral licensing device 100 is a flash memory card for being interfaced with a smart card reader 115 connected to one of the computers 114. For example, off-the-shelf USB memory storage keys or flash memory cards are used as peripheral licensing devices 100. The data indicative of a licensing key and the respective licensing device identification data are, for example, stored in a tamper resistant fashion. Each of a plurality C of users with one of the plurality B of peripheral licensing devices—at 54—and a list of respective licensing device identification data of peripheral licensing devices provided to the users is generated and stored in the memory accessible to the licensing management application—at 55. Optionally, the list is also provided to each of the plurality A of computers 114 for storage thereon. The list is, for example, stored and provided in an obfuscated fashion, for example, as encoded data, to increase security. At 56, data indicative of a total number of users—equal to a number of the subset—is determined. In order to ensure compliance with a licensing agreement with the licensor of the software application, the licensing management application performs at least one of providing the data indicative of the total number to a licensor of the software application and providing the list of respective licensing device identification data of peripheral licensing devices provided to the users to the licensor of the software application—at 57.

After interfacing a peripheral licensing device 100 with one of the computers 114—at 58—the licensing device identification data are retrieved—at 59—and compared—at 60—with the list of respective licensing device identification data of peripheral licensing devices provided to the users to provide a comparison result in dependence thereupon—at 61. If the comparison result is indicative of a match, the data indicative of a licensing key are retrieved and the software application is executed—62A. If the comparison result is indicative of other than a match, execution of the software application is prevented—62B. For example, the list of respective licensing device identification data of peripheral licensing devices provided to the users is stored in each of the computers 114 and the comparison process is performed using a processor of the computer 114. Alternatively, the comparison process is performed using the server 112, or the server 118, however, at the cost of additional communication traffic in the corporate network 110 and dependence upon the network communication and the operation of the server 112 or the servers 112 and 118, respectively. Of course, when the licensing identification data are stored in an obfuscated fashion a step of decoding of the data is executed after their retrieval, which is performed using, for example, the processor of the computer 114.

The second embodiment of the method for secure flexible software licensing according to the invention increases security for the licensor by enabling the same to provide the peripheral licensing devices 100, but retains the flexibility of the first embodiment.

Referring to FIG. 3b, an additional feature increasing flexibility is provided. Here, the licensing management application is executed—63—to erase the respective licensing device identification data of at least one of the peripheral licensing devices from the list of respective licensing device identification data of peripheral licensing devices provided to the users. At 64, second data indicative of a second total number of users are determined. In order to ensure compliance with a licensing agreement with the licensor of the software application, the licensing management application performs at least one of providing the data indicative of the second total number to the licensor of the software application and providing the list of respective licensing device identification data of peripheral licensing devices provided to the users to the licensor of the software application—at 65.

Of course, it is also possible to increase the number of users by storing the respective licensing device identification data in the list of respective licensing device identification data of peripheral licensing devices provided to the users, providing the user with the respective peripheral licensing device, as long as there are more peripheral licensing devices than users, determining third data indicative of a third total number of users, and then providing it to the licensor of the software application.

As is evident, it is possible to integrate the additional features described above with respect to the first embodiment in various combinations into the second embodiment of the method for secure flexible software licensing according to the invention, in order to satisfy predetermined degrees of flexibility and security.

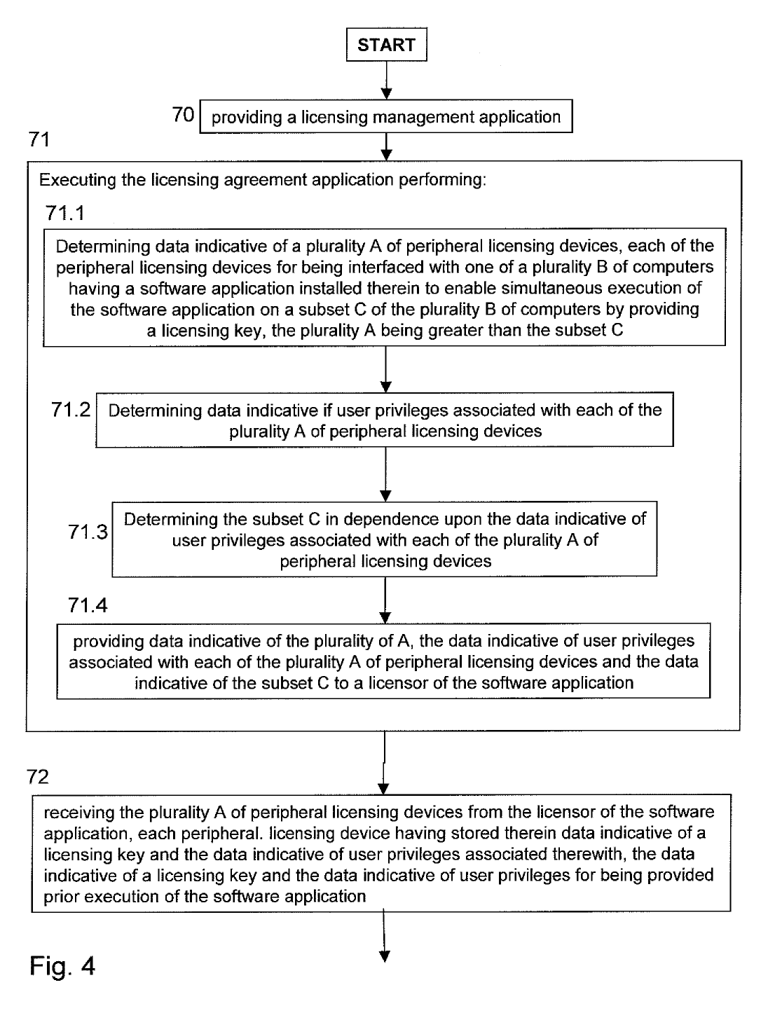

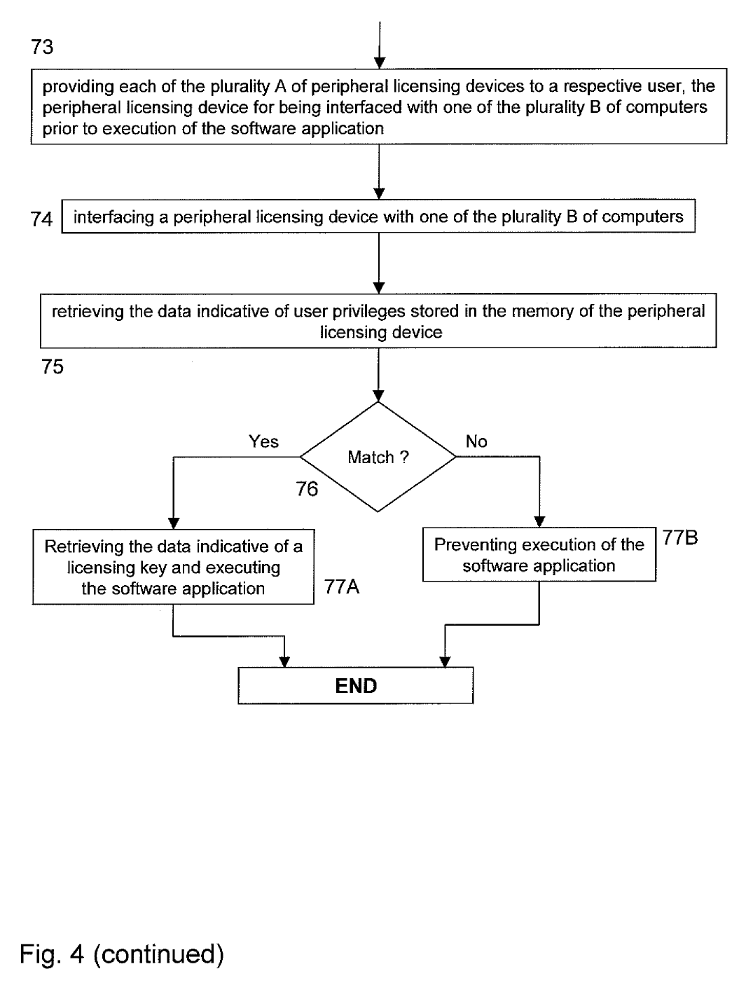

Referring to FIG. 4, a simplified flow diagram of a third embodiment of the method for secure flexible software licensing according to the invention is shown. At 70, a licensing management application is provided, for example, as a download from the licensor's server 118 via the computer network 116 or stored as executable commands on a storage medium such as, for example, a CD or DVD. The licensing management application is then installed and executed by a system administrator, for example, on the server 112. When executing the licensing management application—at 71, data indicative of a plurality A of peripheral licensing devices 100 are determined—at 71.1. Each of the peripheral licensing devices is for being interfaced with one of a plurality B of computers 114 having a software application installed thereon to enable simultaneous execution of the software application on a subset C of the plurality B of computers 114 by providing a licensing key. The plurality A is greater than the subset C. At 71.2, data indicative of user privileges associated with each of the plurality A of peripheral licensing devices 100 are determined, followed by the determination of the subset C in dependence upon the data indicative of user privileges associated with each of the plurality A of peripheral licensing devices—at 71.3. The data indicative of the plurality A, the data indicative of user privileges associated with each of the plurality A of peripheral licensing devices and the data indicative of the subset C are then provided to a licensor of the software application—at 71.4.

At 72, the plurality B of peripheral licensing devices 100 is received from the licensor of the software application. Each peripheral licensing device 100 has stored in memory, data indicative of a licensing key and the data indicative of user privileges associated therewith. The peripheral licensing device 100 is a portable device such as, for example, a Universal Serial Bus (USB) memory storage key for being interfaced with a USB port 113 of one of the computers 114 prior to execution of the software application. Alternatively, the peripheral licensing device 100 is a flash memory card for being interfaced with a smart card reader 115 connected to one of the computers 114. For example, off-the-shelf USB memory storage keys or flash memory cards are used as peripheral licensing devices 100. The data indicative of a licensing key and the data indicative of user privileges are, for example, stored in a tamper resistant fashion. Each respective user is then provided with one of the plurality A of peripheral licensing devices 100—at 73.

After interfacing a peripheral licensing device 100 with one of the computers 114—at 74—the data indicative of user privileges stored in the memory of the peripheral licensing device 100 are retrieved—at 75—and in dependence upon the retrieved data indicative of user privileges—at 76—the data indicative of a licensing key are retrieved and the software application is executed—77A—or execution of the software application is prevented—77B. Of course, when the licensing identification data are stored in an obfuscated fashion a step of decoding of the data is executed after their retrieval, which is performed using, for example, the processor of the computer 114 or, alternatively, a logic circuit disposed in the peripheral licensing device 100.

As is evident, it is possible to integrate the additional features described above with respect to the first embodiment in various combinations into the third embodiment of the method for secure flexible software licensing according to the invention, in order to satisfy predetermined degrees of flexibility and security.

The various embodiments are implemented by providing the licensing management application, for example, as a download from the licensor's server 118 via the computer network 116 or stored as executable commands on a storage medium such as, for example, a CD, DVD, or USB memory storage key. The peripheral licensing device 100 is a portable device such as, for example, a USB memory storage key for being interfaced with a USB port 113 of one of the computers 114 prior to execution of the software application. Alternatively, the peripheral licensing device 100 is a flash memory card for being interfaced with a smart card reader 115 connected to one of the computers 114 For example, off-the-shelf USB memory storage keys or flash memory cards are used as peripheral licensing devices 100.

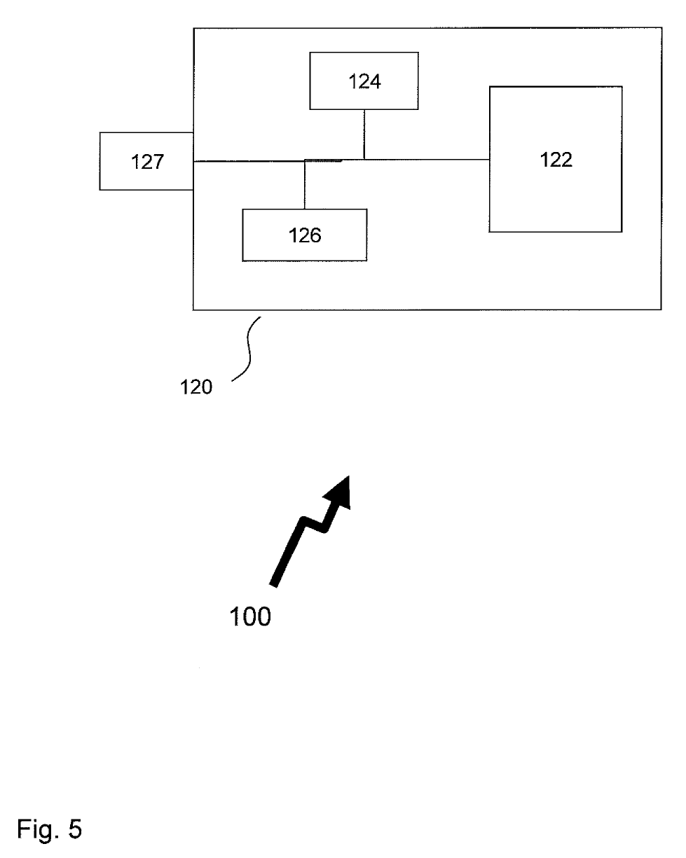

FIG. 5 illustrates a USB memory storage key 100 comprising in a housing 120, memory 122 for storing at least the data indicative of a licensing key thereon connected to port 127 for being interfaced with USB port 113. Optionally, the peripheral licensing device 100 comprises second memory 124 for storing data other than the data indicative of a licensing key. Further optionally, the peripheral licensing device 100 comprises a logic circuit 126 connected to the port 127 and the memory 122. Providing second memory allows, for example, a licensor to provide the peripheral licensing device 100 having data stored in the memory 122 in a tamper resistant fashion while enabling a licensee to store additional data in the second memory 124. As is evident, it is also possible to provide a flash memory card comprising similar components.

Of course, it is envisaged that other similar portable memory storage devices, including those yet to be invented, may be used in place of USB memory storage keys or flash memory cards. The USB memory storage keys or flash memory cards are merely two non-limiting examples of currently available, portable memory storage devices that are suitable for use with the embodiments of the instant invention.

Numerous other embodiments of the invention will be apparent to persons skilled in the art without departing from the scope of the invention as defined in the appended claims.

What is claimed is:

1. A method comprising:
providing a licensing management application;
receiving data indicative of licensing privileges of a software application for simultaneous execution on a subset of a plurality A of computers having the software application installed thereon, the data indicative of licensing privileges comprising respective licensing device identification data of each of a plurality B of peripheral licensing devices, the data indicative of licensing privileges being received by the licensing management application;
storing the respective licensing device identification data of each of the plurality B of peripheral licensing devices in memory accessible to the licensing management application;
receiving the plurality B of peripheral licensing devices from a licensor of the software application, each peripheral licensing device having stored thereon data indicative of a licensing key and the respective licensing device identification data, the data indicative of a licensing key for being provided prior execution of the software application;
providing each of a plurality C of users with one of the plurality B of peripheral licensing devices, the peripheral licensing device for being interfaced with one of the computers prior to execution of the software application;
generating a list of respective licensing device identification data of peripheral licensing devices provided to the users and storing the same in the memory accessible to the licensing management application;
determining data indicative of a total number of users; and,
performing at least one of providing the data indicative of the total number to a licensor of the software application and providing the list of respective licensing device identification data of peripheral licensing devices provided to the users to the licensor of the software application.

2. A method as defined in claim 1 comprising:
interfacing a peripheral licensing device with one of the computers;
retrieving the licensing device identification data;
comparing the licensing device identification data with the list of respective licensing device identification data of peripheral licensing devices provided to the users and providing a comparison result in dependence thereupon;
retrieving the data indicative of a licensing key and executing the software application if the comparison result is indicative of a match; and,
preventing execution of the software application if the comparison result is indicative of other than a match.

3. A method as defined in claim 1 comprising:
erasing the respective licensing device identification data of at least one of the peripheral licensing devices from the list of respective licensing device identification data of peripheral licensing devices provided to the users;
determining second data indicative of a second total number of users; and,
performing at least one of providing the data indicative of the second total number of users to a licensor of the software application and providing the list of respective licensing device identification data of peripheral licensing devices provided to the users to the licensor of the software application.

4. A method as defined in claim 1 wherein the list of respective licensing device identification data of peripheral licensing devices provided to the users is stored in memory of at least one of:
a) each of the plurality of computers having the software application installed thereon;
b) a server connected to the computer via a corporate network; and,
c) a computer system of the licensor of the software application.

5. A method as defined in claim 2 comprising:
determining data indicative of user privileges for each of the plurality C of users of the software application;
storing for each user the data indicative of user privileges of the user in memory of the respective peripheral licensing device; and,
determining the data indicative of a total number of users resulting in a simultaneous execution of the software application in dependence upon the data indicative of user privileges of the plurality of users of the software application.

6. A method as defined in claim 5 comprising:
retrieving the data indicative of user privileges stored in the memory of the peripheral licensing device;
in dependence upon the data indicative of user privileges performing one of:
retrieving the data indicative of a licensing key and executing the software application; and,
preventing execution of the software application.

7. A method as defined in claim 1 comprising storing in memory of each of the plurality of licensing devices provided to a user, authorization data indicative of an authorized user of the respective peripheral licensing device.

8. A method as defined in claim 7 comprising:
providing user authorization data;
retrieving the user authorization data from the memory of the peripheral licensing device;
comparing the provided user authorization data with the retrieved user authorization data and providing a comparison result in dependence thereupon;
retrieving the data indicative of a licensing key and executing the software application if the comparison result is indicative of a match; and,
preventing execution of the software application if the comparison result is indicative of other than a match.

9. A method comprising:
providing a licensing management application;
executing the licensing management application comprising performing:
determining data indicative of a plurality A of peripheral licensing devices, each of the peripheral licensing devices for being interfaced with one of a plurality B of computers having a software application installed thereon to enable simultaneous execution of the software application on a subset C of the plurality B of computers by providing a licensing key, the plurality A being one of equal to and greater than the subset C;
determining data indicative of user privileges associated with each of the plurality A of peripheral licensing devices;
determining the subset C in dependence upon the data indicative of user privileges associated with each of the plurality A of peripheral licensing devices; and,
providing the data indicative of the plurality A, the data indicative of user privileges associated with each of the plurality A of peripheral licensing devices and the data indicative of the subset C to a licensor of the software application;
receiving the plurality A of peripheral licensing devices from the licensor of the software application, each peripheral licensing device having stored thereon data indicative of a licensing key and the data indicative of user privileges associated therewith, the data indicative of a licensing key and the data indicative of user privileges for being provided prior execution of the software application; and,
providing each of the plurality A of peripheral licensing devices to a respective user, the peripheral licensing device for being interfaced with one of the plurality B of computers prior to execution of the software application.

10. A method as defined in claim 9 comprising:
interfacing a peripheral licensing device with one of the plurality B of computers;
retrieving the data indicative of user privileges stored in the memory of the peripheral licensing device;
in dependence upon the data indicative of user privileges, performing one of:
retrieving the data indicative of a licensing key and executing the software application; and,
preventing execution of the software application.

11. A method as defined in claim 10 comprising when executing the licensing management application, performing:
generating for each of the plurality A of peripheral licensing devices user authorization data indicative of an authorized user associated therewith; and,
storing in memory of each of the plurality A of licensing devices the respective user authorization data.

12. A method as defined in claim 11 comprising:
receiving user authorization data;
retrieving the user authorization data from the memory of the peripheral licensing device;
comparing the received user authorization data with the retrieved user authorization data and providing a comparison result in dependence thereupon;
retrieving the data indicative of a licensing key and executing the software application if the comparison result is indicative of a match; and,
preventing execution of the software application if the comparison result is indicative of other than a match.

13. A system comprising:
a plurality A of peripheral licensing devices, each of the peripheral licensing devices for being interfaced with one of a plurality B of computers having a software application installed thereon, each of the plurality A of peripheral licensing devices comprising:
a port for communicating with a host computer; and,
first memory connected to the port, the first memory having stored thereon data indicative of a licensing key of the software application and respective licensing device identification data;
and,
a storage medium having stored thereon executable commands for execution on a processor, the processor when executing the commands executing a licensing management application and performing:
receiving data indicative of licensing privileges of a software application for simultaneous execution on a subset of the plurality B of computers having the software application installed thereon, the data indicative of licensing privileges comprising respective licensing device identification data of each of the plurality A of peripheral licensing devices;
storing the respective licensing device identification data of each of the plurality A of peripheral licensing devices in memory accessible to the licensing management application;
generating a list of respective licensing device identification data of peripheral licensing devices provided to the users and storing the same in the memory accessible to the licensing management application;
determining data indicative of a total number of users; and,
performing at least one of providing the data indicative of the total number to a licensor of the software application and providing the list of respective licensing device identification data of peripheral licensing devices provided to the users to the licensor of the software application.

14. A system as defined in claim 13 wherein each of the peripheral licensing devices is portable.

15. A system as defined in claim 13 wherein the port of each of the peripheral licensing devices is a universal serial bus (USB) port.

16. A system as defined in claim 13 wherein each of the peripheral licensing devices is a one of a USB memory storage key and a flash memory card.

17. A system as defined in claim 15 wherein each of the peripheral licensing devices comprises second memory for storing at least one of data indicative of user privileges and user authorization data indicative of an authorized user.

18. A system as defined in claim 17 wherein each of the peripheral licensing devices comprises logic circuitry connected to the port, the first memory and the second memory.

19. A system comprising:
a storage medium having stored thereon executable commands for execution on a processor, the processor when executing the commands executing a licensing management application and performing:
determining data indicative of a plurality A of peripheral licensing devices, each of the peripheral licensing devices for being interfaced with one of a plurality B of computers having a software application installed thereon to enable simultaneous execution of the software application on a subset C of the plurality B of computers by providing a licensing key, the plurality A being one of equal to and greater than the subset C;
determining data indicative of user privileges associated with each of the plurality A of peripheral licensing devices;
determining the subset C in dependence upon the data indicative of user privileges associated with each of the plurality A of peripheral licensing devices; and,
providing the data indicative of the plurality A, the data indicative of user privileges associated with each of the plurality A of peripheral licensing devices and the data indicative of the subset C to a licensor of the software application;
and,
a plurality A of peripheral licensing devices, each of the peripheral licensing devices for being interfaced with one of a plurality B of computers having a software application installed thereon to enable simultaneous execution of the software application on a subset C of the plurality B of computers by providing a licensing key, the plurality A being greater than the subset C, each of the peripheral licensing devices comprising:
a port for communicating with a host computer; and,
first memory connected to the port, the first memory having stored thereon data indicative of a licensing key of the software application and data indicative of user privileges associated with the peripheral licensing device.

20. A system as defined in claim 19 wherein each of the peripheral licensing devices is portable.

21. A system as defined in claim 19 wherein the port of each of the peripheral licensing devices is a universal serial bus (USB) port.

22. A system as defined in claim 19 wherein each of the peripheral licensing devices is a one of a USB memory storage key and a flash memory card.

23. A system as defined in claim 22 wherein each of the peripheral licensing devices comprises second memory for storing user authorization data indicative of an authorized user.

24. A system as defined in claim 23 wherein each of the peripheral licensing devices comprises logic circuitry connected to the port, the first memory and the second memory.
